(19) United States
(12) Patent Application Publication
(10) Pub. No.: US 2018/0364767 A1
(43) Pub. Date: Dec. 20, 2018

(54) HINGE CONNECTOR AND ELECTRONIC APPARATUS

(71) Applicant: FUJITSU LIMITED, Kawasaki-shi (JP)

(72) Inventor: Nobuhiko Onda, Yokohama (JP)

(73) Assignee: FUJITSU LIMITED, Kawasaki-shi (JP)

(21) Appl. No.: 16/005,279

(22) Filed: Jun. 11, 2018

(30) Foreign Application Priority Data
Jun. 19, 2017 (JP) 2017-119512

(51) Int. Cl. G06F 1/16; E05D 3/02; E05D 11/00; E05D 7/00; E05D 11/10

(52) U.S. Cl. CPC G06F 1/1681; G06F 1/1616; G06F 1/1683; E05Y 2900/606; E05D 11/0081; E05D 7/00; E05D 11/1014; E05D 3/02

(57) ABSTRACT

A hinge connector includes, a hinge that includes a rotation shaft and a support cylinder rotatably supporting the rotation shaft, a cable that is wound on an outer periphery of the hinge, and a spring that biases one end side of the cable in a longitudinal direction thereof toward a side away from the hinge along a direction perpendicular to an axial direction of the hinge.

### CROSS-REFERENCE TO RELATED APPLICATION

This application is based upon and claims the benefit of priority of the prior Japanese Patent Application No. 2017-119512, filed on Jun. 19, 2017, the entire contents of which are incorporated herein by reference.

### FIELD

The embodiments discussed herein are related to a hinge connector and an electronic apparatus.

### BACKGROUND

In folding electronic apparatuses, for example as laptop personal computers, a display is supported on a control circuitry in an openable and closable manner by using a hinge connector. Also, in some of these folding electronic apparatuses, the display and the control circuitry are coupled by a cable, and the cable is wound on the outer periphery of a hinge provided in the hinge connector.

In a hinge connector with a cable wound on the outer periphery of its hinge, the cable may slack with an opening action of the hinge connector. Here, when the cable slacks as above, there is a possibility that the slack portion of the cable interferes with its surroundings and makes a smooth opening action of the hinge connector impossible.

Related techniques are disclosed, for example, in Japanese Laid-open Patent Publication Nos. 2011-119698, 2002-327733, 2004-052373, and 2002-252069.

### SUMMARY

According to an aspect of the embodiments, a hinge connector includes, a hinge that includes a rotation shaft and a support cylinder rotatably supporting the rotation shaft, a cable that is wound on an outer periphery of the hinge, and a spring that biases one end side of the cable in a longitudinal direction thereof toward a side away from the hinge along a direction perpendicular to an axial direction of the hinge.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a perspective view illustrating a state where a display of an electronic apparatus according an embodiment is closed;

FIG. 2 is a perspective view illustrating a state where the display of the electronic apparatus illustrated in FIG. 1 is opened to a maximum angle;

FIG. 3 is a side view illustrating a state where the display of the electronic apparatus illustrated in FIG. 1 is opened vertically;

FIG. 4 is a perspective view of the electronic apparatus illustrated in FIG. 1 with a partial cross section thereof and is a perspective view illustrating the state where the display is closed;

FIG. 5 is a perspective view of the electronic apparatus illustrated in FIG. 1 with a partial cross section thereof and is a perspective view illustrating the state where the display is opened vertically;

FIG. 6 is an enlarged perspective view of a main part of a hinge connector and its surroundings illustrated in FIGS. 4 and 5;

FIG. 7 is a perspective view of the hinge connector illustrated in FIG. 6 as seen diagonally from the front;

FIG. 8 is a perspective view of the hinge connector illustrated in FIG. 6 as seen diagonally from the rear;

FIG. 9 is a perspective view of the hinge connector illustrated in FIG. 6 as seen diagonally from a side;

FIG. 10 is an exploded perspective view of the hinge connector illustrated in FIG. 6;

FIG. 11 is an enlarged perspective view of a main part of the hinge connector and its surroundings illustrated in FIG. 6;

FIG. 12 is a perspective view of the hinge connector and its surroundings illustrated in FIG. 11;

FIG. 13 is a two-view drawing (plan view and side view) of the hinge connector illustrated in FIG. 6;

FIG. 14 is a set of views illustrating opening and closing actions of the hinge connector illustrated in FIG. 6;

FIG. 15 is a set of views explaining the opening action of the hinge connector alone illustrated in FIG. 6;

FIG. 16 is a set of views explaining the opening action of the display and the hinge connector illustrated in FIG. 6;

FIG. 17 is a set of views explaining the closing action of the display and the hinge connector illustrated in FIG. 6;

FIG. 18 is a perspective view illustrating a first modification of the embodiment;

FIG. 19 is a perspective view illustrating a second modification of the embodiment; and

FIG. 20 is a view illustrating a state without a cable in the second modification illustrated in FIG. 19.

### DESCRIPTION OF EMBODIMENT

An embodiment of the technique disclosed by the present application will be described below.

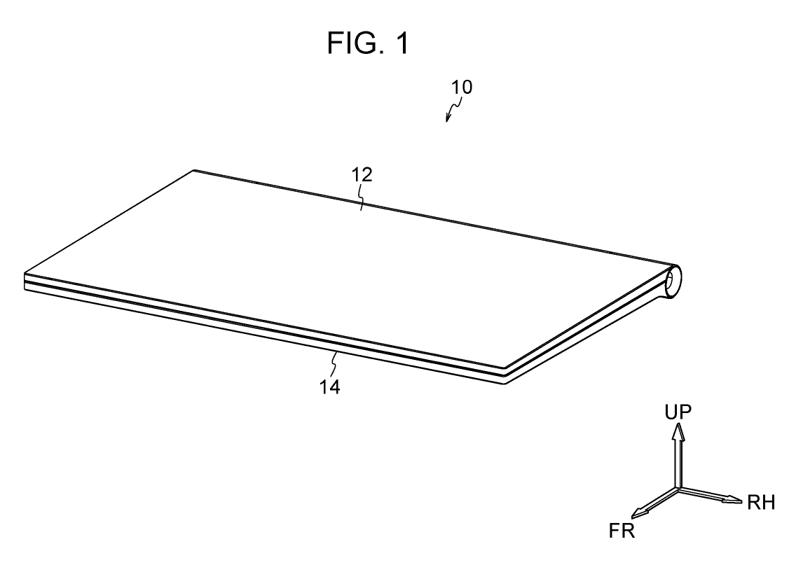

In FIGS. 1 to 3, an electronic apparatus 10 according to the embodiment is illustrated. In one example, the electronic apparatus 10 according to this embodiment is a laptop personal computer. This electronic apparatus 10 includes a display 12 and a control circuitry 14.

The display 12 and the control circuitry 14 are each in a flat plate shape (flat board shape). The display 12 is provided with a display housing 16. On the other hand, the control circuitry 14 houses a control board, a battery, and so on not illustrated for driving the display 12.

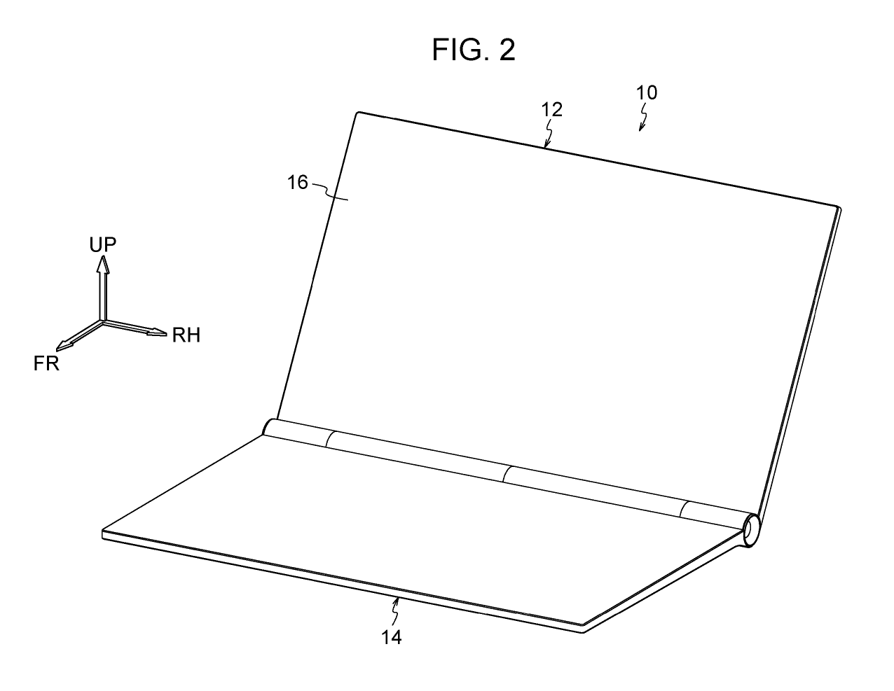

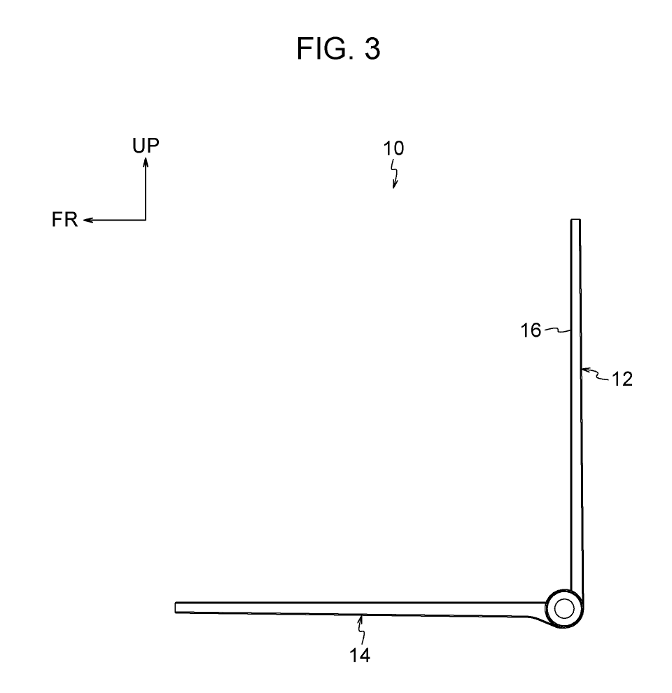

The display 12 is supported on the control circuitry 14 in an openable and closable manner. The display 12 is illustrated in a closed state in FIG. 1 while the display 12 is illustrated in a state where it is opened to a maximum angle in FIG. 2. Also, the display 12 is illustrated in a vertically opened state in FIG. 3.

Meanwhile, arrows FR, UP, and RH illustrated in the drawings indicate a front side, an upper side, and a right side in the front-rear direction (depth direction), the top-bottom direction (height direction), and the left-right direction (width direction) of the electronic apparatus 10, respectively.

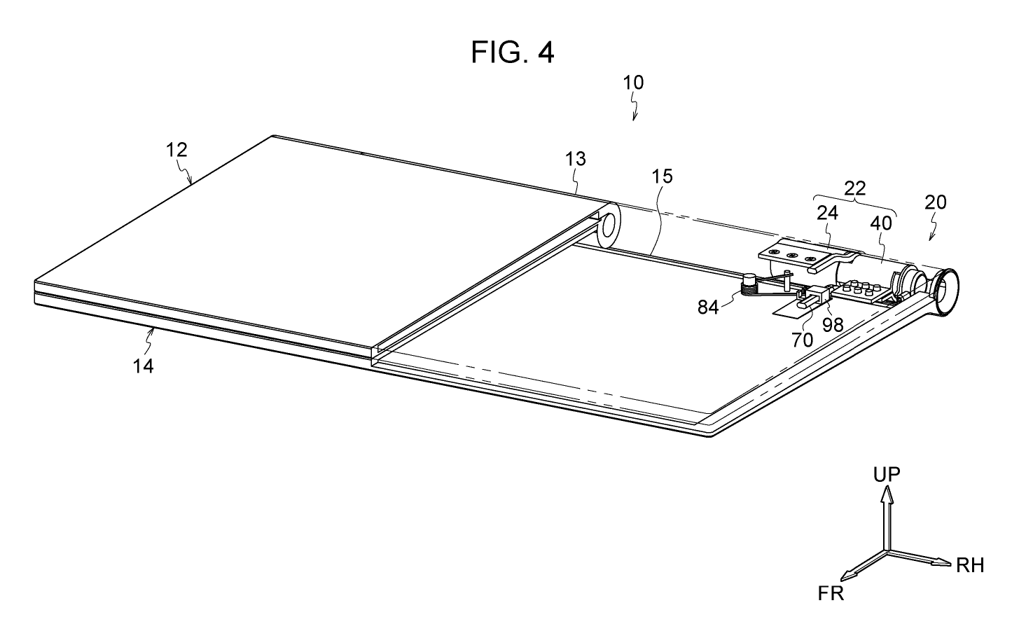

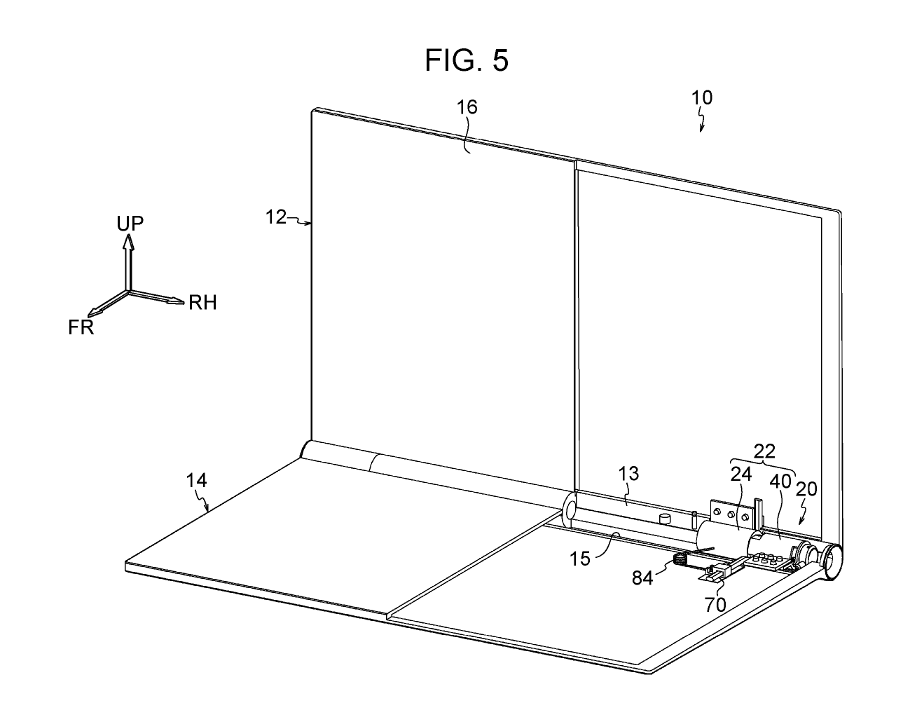

In FIGS. 4 and 5, the electronic apparatus 10 is illustrated with a partial cross section. The display 12 is illustrate in the closed state in FIG. 4 while the display 12 is illustrated in the vertically opened state in FIG. 5. As illustrated in FIGS. 4 and 5, the electronic apparatus 10 includes a hinge connector 20. The hinge connector 20 couples one end 13 (lower end) of the display 12 rotatably to one end 15 (rear end) of the control circuitry 14.

Although the hinge connector 20 is illustrated only on the right side in FIGS. 4 and 5, the electronic apparatus 10 includes the hinge connector 20 on each of the left and right sides. This pair of left and right hinge connectors are laterally symmetrical. In the following, the hinge connector 20 on the right side will be described, and description of the hinge connector on the left side will be omitted.

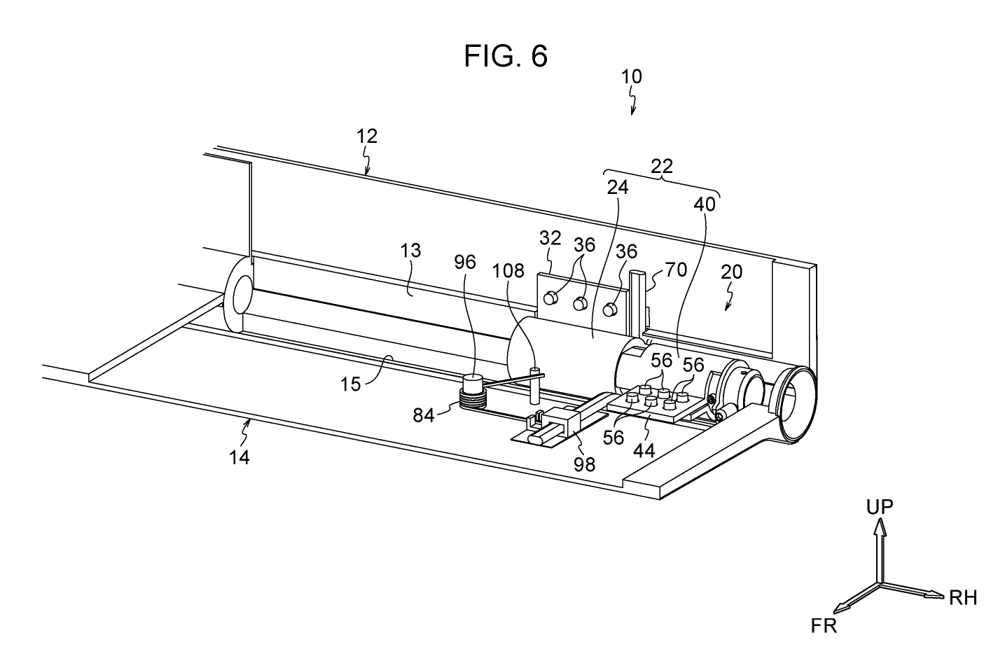

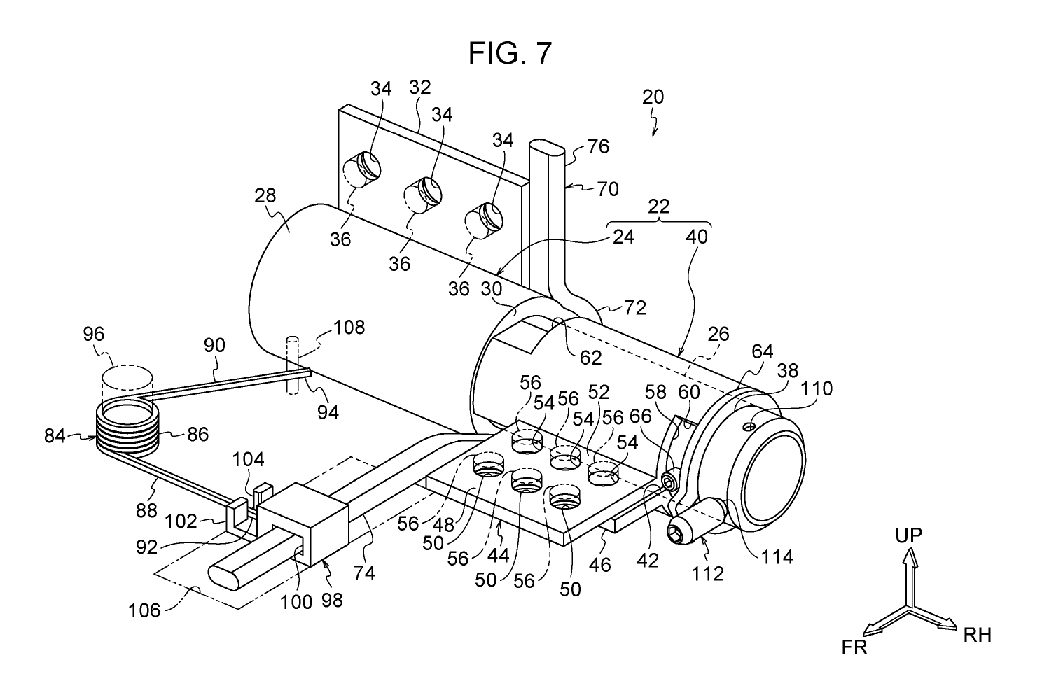

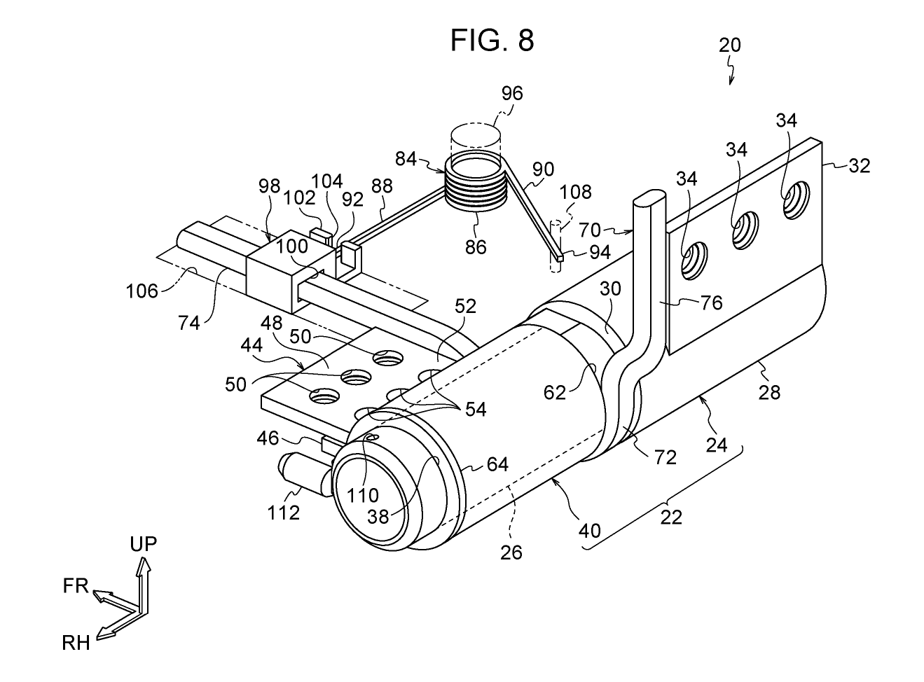

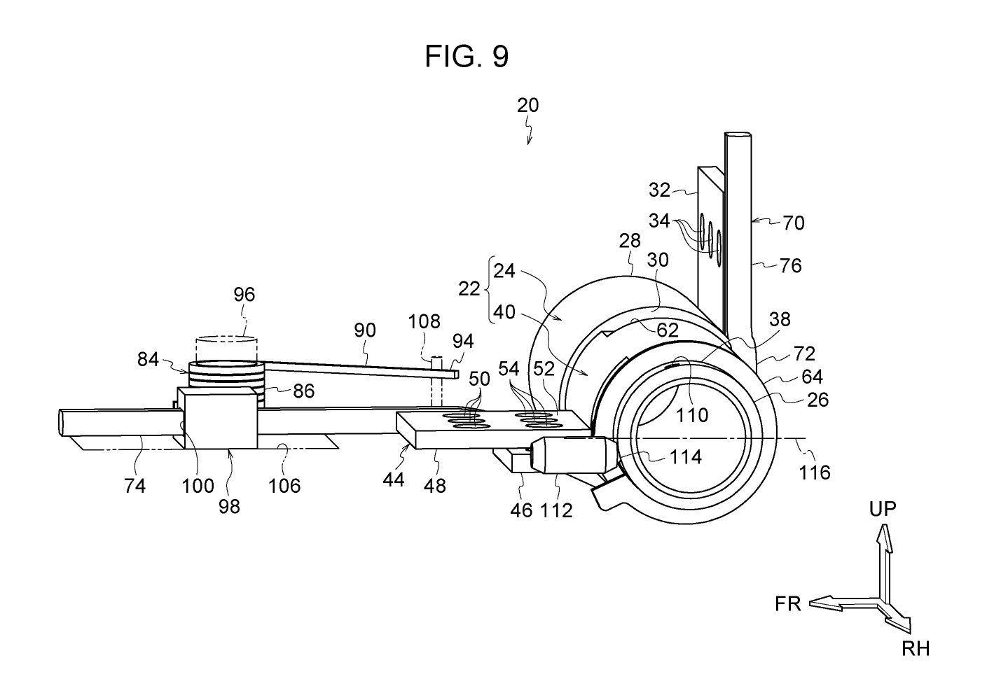

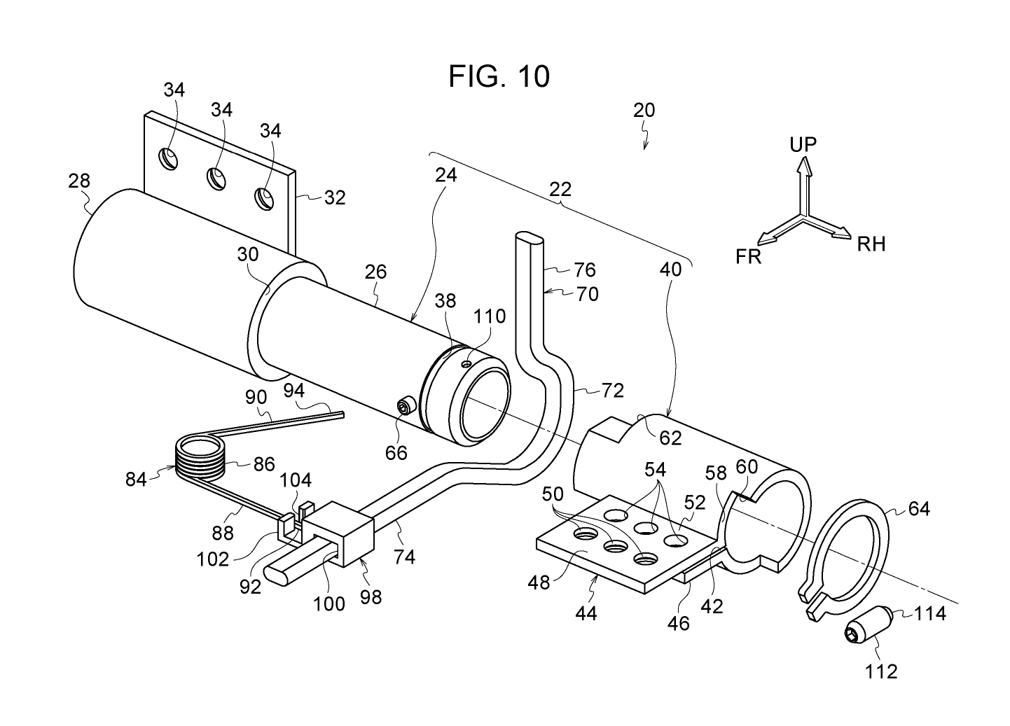

The hinge connector 20 and its surroundings illustrated in FIGS. 4 and 5 are illustrated enlarged in FIG. 6. Also, FIGS. 7 to 9 illustrate perspective views of the hinge connector 20, and FIG. 10 illustrates an exploded perspective view of the hinge connector 20. In FIGS. 6 to 10, the hinge connector 20 in the state where the display 12 is opened vertically is illustrated.

As illustrated in FIGS. 6 to 10, the hinge connector 20 according to this embodiment includes a hinge 22. The hinge 22 includes a rotation shaft 24 provided to the display 12 and a support cylinder 40 provided to the control circuitry 14.

The rotation shaft 24 is in a hollow cylindrical shape entirely penetrated in its axial direction. This rotation shaft 24 penetrates through the support cylinder 40 in the axial direction. This rotation shaft 24 is disposed such that the left-right direction of the display 12 is its axial direction. The rotation shaft 24 includes a first shaft portion 26, a second shaft portion 28, and a step portion 30. The first shaft portion 26 is formed to be smaller in outer diameter than the second shaft portion 28, and the step portion 30 is formed between the first shaft portion 26 and the second shaft portion 28. The first shaft portion 26 is located on an outer side in the left-right direction of the display 12 relative to the second shaft portion 28.

On the outer periphery of the second shaft portion 28, a first fixing portion 32 in a flat plate shape is provided which extends along the radial direction of the second shaft portion 28. This first fixing portion 32 is disposed such that the thickness direction of the display 12 is its plate thickness direction. This first fixing portion 32 extends toward the opposite end (upper end) of the display 12 along the radial direction of the rotation shaft 24.

In this first fixing portion 32, a plurality of through-holes 34 are formed which penetrate through the first fixing portion 32 in its thickness direction. The first fixing portion 32 is fixed to the display 12 by inserting screws 36 (see FIG. 6) into the plurality of through-holes 34 and screwing these screws 36 into screw holes in the display 12.

The support cylinder 40 is disposed such that the left-right direction of the display 12 is its axial direction. This support cylinder 40 is provided based on the first shaft portion 26, which is formed a part of the rotation shaft 24, and disposed on the radially outer side of the first shaft portion 26.

This support cylinder 40 is in a surrounding shape curved along the circumferential direction of the first shaft portion 26 and surrounding the outer periphery of the first shaft portion 26. Also, this support cylinder 40 is in an open shape including an open portion 42 (slit) as one portion thereof in the circumferential direction. In other words, this support cylinder 40 is formed nearly in the shape of a hollow cylinder with a C-shaped cross section. This support cylinder 40 rotatably supports the rotation shaft 24 by surrounding the outer periphery of the first shaft portion 26.

A pair of second fixing portions 44, 46 are provided at the opposite circumferential ends of the C-shape of this support cylinder 40. The pair of second fixing portions 44, 46 are each formed in a flat plate shape. This pair of second fixing portions 44, 46 are disposed such that the thickness direction of the control circuitry 14 is their thickness direction, and face each other in the top-bottom direction of the control circuitry 14. Also, this pair of second fixing portions 44, 46 each extend toward the front side of the control circuitry 14 along the radial direction of the support cylinder 40.

One of the second fixing portions, namely, the second fixing portion 44, includes an extending portion 48 extending toward the front side of the control circuitry 14 beyond the other second fixing portion 46. In this extending portion 48, a plurality of through-holes 50 are formed which penetrate therethrough in the thickness direction of the one second fixing portion 44. Moreover, in a portion 52 of the one second fixing portion 44 facing the opposite second fixing portion 46, a plurality of through-holes 54 are formed which penetrate therethrough in the thickness direction of the one second fixing portion 44.

Further, a plurality of through-holes similar to the plurality of through-holes 54 are also formed in the opposite second fixing portion 46 at positions coinciding with the plurality of through-holes 54. Then, the pair of second fixing portions 44, 46 are fixed to the display 12 by inserting screws 56 (see FIG. 6) into the pluralities of through-holes 50, 54 and screwing these screws 56 into screw holes in the display 12.

Also, as the screws 56 inserted in the pluralities of through-holes 50, 54 are screwed into the screw holes in the display 12, the gap between the pair of second fixing portions 44, 46 is narrowed, so that the inner periphery of the support cylinder 40 is brought into tight contact with the outer periphery of the first shaft portion 26. With the inner periphery of the support cylinder 40 brought into tight contact with the outer periphery of the first shaft portion 26 as above, the support cylinder 40 functions as a friction torque mechanism that generates friction torque between itself and the rotation shaft 24. Meanwhile, the inner diameter of the support cylinder 40, the width of the open portion 42, and so on are set so as to enable the support cylinder 40 to generate the desired friction torque on the rotation shaft 24.

A tip portion of the first shaft portion 26 disposed inside this support cylinder 40 projects from the support cylinder 40. In this tip portion of the first shaft portion 26, a fixing groove 38 is formed which extends in the circumferential direction of the first shaft portion 26. A retaining washer 64 in a C-shape in a side view is fitted in this fixing groove 38, thereby keeping the rotation shaft 24 from being disengaged from the support cylinder 40.

Also, on the tip side of the first shaft portion 26, a protrusion 66 is provided which protrudes in the radial direction of the first shaft portion 26. On the other hand, in a portion of the support cylinder 40 coinciding with the protrusion 66, that is, an end portion of the support cylinder 40 by the tip of the first shaft portion 26, a cutout 58 is formed which is cut in the axial direction of the support cylinder 40.

The protrusion 66 is inserted in this cutout 58 movably along the circumferential direction of the support cylinder 40. The protrusion 66 and the cutout 58 function as an angle defining mechanism that defines an opening angle of the display 12. Specifically, the maximum opening angle of the display 12 is defined with the protrusion 66 in contact with one end 60 of the cutout 58 in its width direction.

The hinge connector 20 according to this embodiment further includes a flexible cable 70. This cable 70 connects the display 12 and the control circuitry 14 to each other. For example, the cable 70 connects the display unit 16 of the display 12 and the control board of the control circuitry 14 to each other inside the display 12 and the control circuitry 14.

On the step portion 30 side of the support cylinder 40, a cutout 62 is formed which is cut in the axial direction of the support cylinder 40, and an intermediate portion 72 of the cable 70 in its longitudinal direction is wound on the outer periphery of the first shaft portion 26 through the cutout 62. Specifically, this intermediate portion 72 of the cable 70 in the longitudinal direction is wound on the outer periphery of the first shaft portion 26 to make a single winding at most along the circumferential direction of the outer periphery of the first shaft portion 26. This intermediate portion 72 of the cable 70 in the longitudinal direction is a portion between one end side 74 and an opposite end side 76 of the cable 70 in the longitudinal direction.

The one end side 74 of the cable 70 in the longitudinal direction (a portion on one end side) is routed inside the control circuitry 14 and extends along the front-rear direction of the control circuitry 14. On the other hand, the opposite end side 76 of the cable 70 in the longitudinal direction (a portion on the opposite end side) is routed inside the display 12 and extends along the top-bottom direction of the display 12.

Note that the one end of the cable 70 is fixed to the control circuitry 14 by, for example, being connected to the control board inside the control circuitry 14. Also, the opposite end of the cable 70 is fixed to the display 12 by, for example, being connected to the display unit 16 inside the display 12.

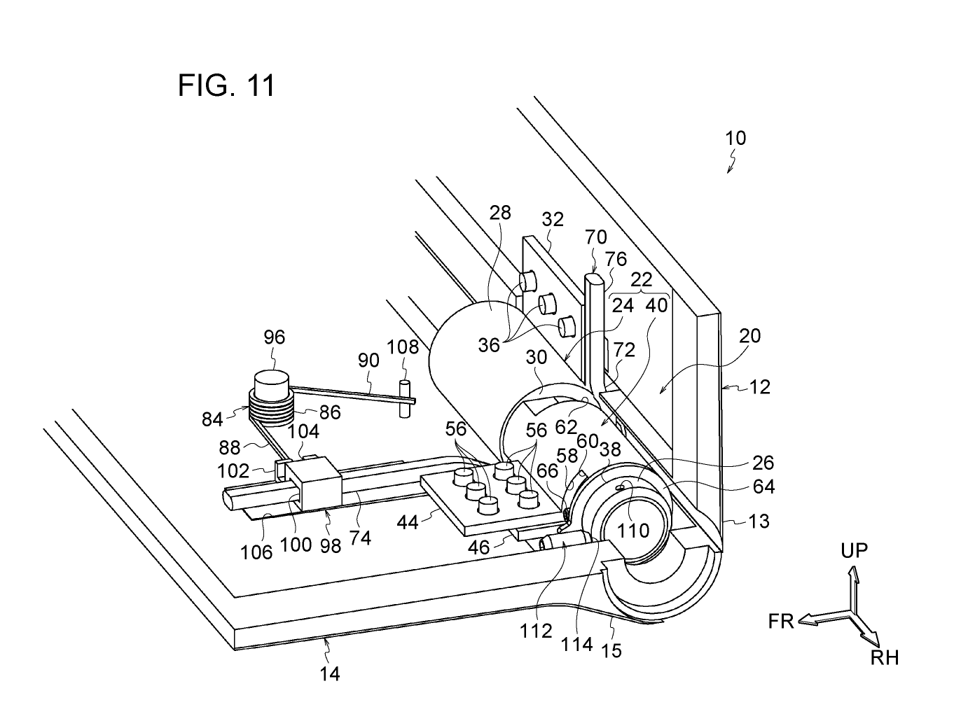

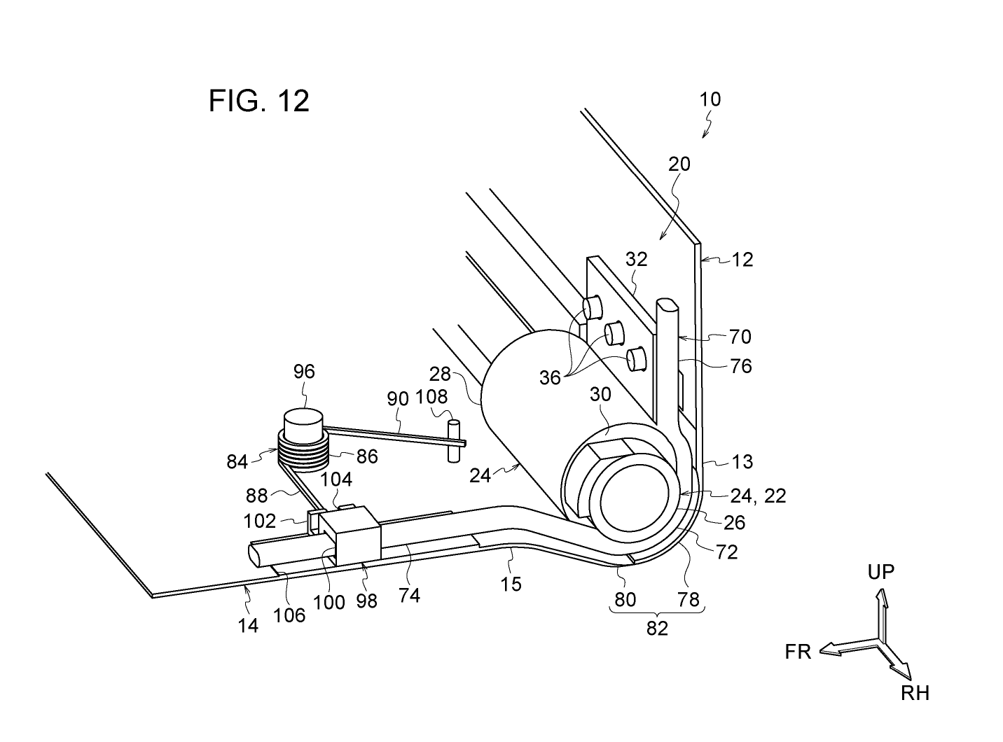

The hinge connector 20 and its surroundings are illustrated enlarged in FIGS. 11 and 12. As illustrated in FIGS. 11 and 12, as a part of the housing of the display 12, a first cover 78 is formed which extends toward the lower side of the display 12, and as a part of the housing of the control circuitry 14, a second cover 80 is formed which extends toward the rear side of the control circuitry 14.

The first cover 78 and the second cover 80 are formed in an arched shape in cross section curved along the outer periphery of the hinge 22 and cover the outer periphery of the hinge 22. Also, the position of the first cover 78 is set such that it is situated radially inside the second cover 80 when an opening action of the hinge connector 20 is performed.

The first cover 78 and the second cover 80 form a cover 82. This cover 82 is provided in proximity to the outer periphery of the hinge 22. A gap in an arched shape as seen from the axial direction of the hinge 22 is formed between the outer periphery of the hinge 22 (more specifically, the outer periphery of the first shaft portion 26 of the rotation shaft 24) and the inner periphery of the cover 82.

The intermediate portion 72 of the cable 70 in the longitudinal direction, which is wound on the outer periphery of the first shaft portion 26, is inserted in this gap. The intermediate portion 72 of the cable 70 in the longitudinal direction is interposed between the outer periphery of the hinge 22 (more specifically, the outer periphery of the first shaft portion 26 of the rotation shaft 24) and the inner periphery of the cover 82. More specifically, this intermediate portion 72 of the cable 70 in the longitudinal direction is in contact with the outer periphery of the first shaft portion 26 and the inner periphery of the cover 82.

Meanwhile, in the hinge connector 20 according to this embodiment, the intermediate portion 72 of the cable 70 in the longitudinal direction is wound on the outer periphery of the hinge 22, as mentioned above. With this hinge connector 20, in the course of the opening action of the hinge connector 20, the one end 13 (rear end) of the display 12 gets close to the one end 15 (lower end) of the control circuitry 14. As a result, the intermediate portion 72 of the cable 70 in the longitudinal direction slacks in some cases.

In addition, in this embodiment, the cover 82 is provided in proximity to the outer periphery of the hinge 22, so that the routing space for the cable 70 around the hinge 22 is narrow. Then, if the intermediate portion 72 of the cable 70 in the longitudinal direction slacks in the course of the opening action of the hinge connector 20, the slack portion of the cable 70 possibly interferes with the cover 82 or is caught between the hinge 22 and the cover 82. Cable slack possibly leads to a failure to perform a smooth opening action of the hinge connector 20 and thus a failure to smoothly open the display 12.

In view of this, the hinge connector 20 in this embodiment uses a pulling mechanism that pulls the cable 70 in order to suppress the slacking of the intermediate portion 72 of the cable 70 in the longitudinal direction during the opening action of the hinge connector 20. This pulling mechanism includes a torsion spring 84 and a connection block 98.

The torsion spring 84 is an example of “spring”. The torsion spring 84 is provided inside the control circuitry 14 and is disposed such that the top-bottom direction of the control circuitry 14 is its axial direction. Also, this torsion spring 84 is disposed on the front side of the control circuitry 14 relative to the hinge 22 and on the center side of the control circuitry 14 in the left-right direction relative to the one end side 74 of the cable 70 in the longitudinal direction.

This torsion spring 84 includes a spiral portion 86 and a pair of arm portions 88, 90 extending from the spiral portion 86 in directions tangent to the spiral portion 86. On the bottom wall of the housing of the control circuitry 14, a solid cylindrical portion 96 is formed which extends toward the upper side of the control circuitry 14. With the solid cylindrical portion 96 inserted in the spiral portion 86, the torsion spring 84 is held on the solid cylindrical portion 96.

The connection block 98 is formed in a block shape. This connection block 98 includes a through-hole 100 penetrating through the connection block 98 in its front-rear direction. The connection block 98 is fixed to the one end side 74 of the cable 70 in the longitudinal direction with the one end side 74 of the cable 70 in the longitudinal direction inserted in this through-hole 100. In the bottom wall of the housing of the control circuitry 14, a guide groove 106 is formed which extends in the front-rear direction of the control circuitry 14 (the longitudinal direction of the cable 70). The connection block 98 is inserted in the guide groove 106 movably in the front-rear direction of the control circuitry 14.

On a side of the connection block 98, a hook 102 is formed which protrudes toward the torsion spring 84. The hook 102 is in a catch shape (recessed shape) with a cutout 104 opened on the torsion spring 84 side. The one end portion 92 of the torsion spring 84 (a tip portion of one of the arm portions, namely the arm portion 88) is inserted in the cutout 104 to be caught on the hook 102.

The cutout 104 is formed to be wider than the one end portion 92 of the torsion spring 84, and the one end portion 92 of the torsion spring 84 is movably inserted in the cutout 104. On the bottom wall of the housing of the control circuitry 14, a protruding portion 108 is formed which extends toward the upper side of the control circuitry 14. An opposite end portion 94 of the torsion spring 84 (a tip portion of the opposite arm portion 90) is brought into contact with the protruding portion 108 from the front side of the control circuitry 14.

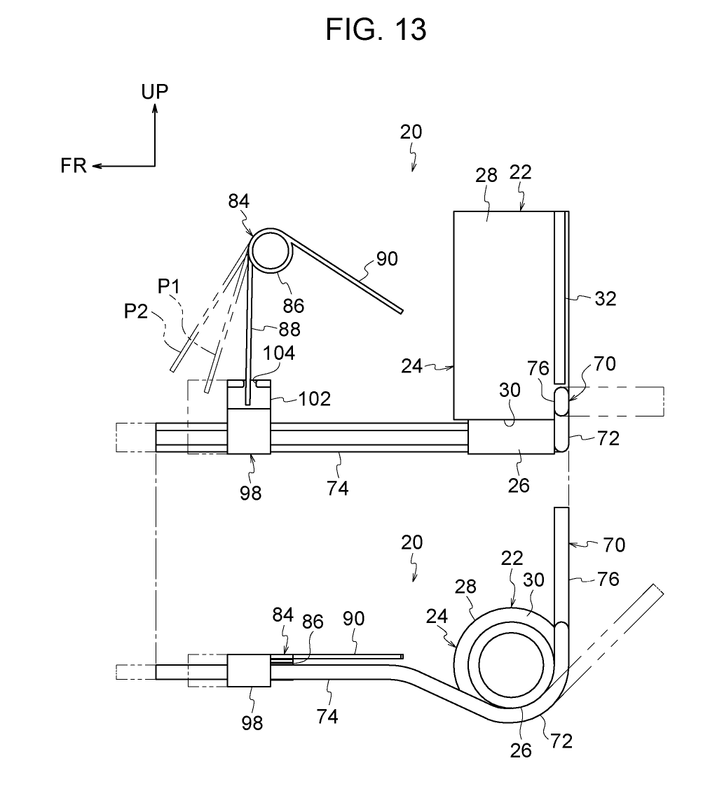

FIG. 13 is a two-view drawing (plan view and side view) of the hinge connector 20. In FIG. 13, the display 12 is the vertically opened state. As illustrated in FIG. 13, in this embodiment, the shape and so on of the torsion spring 84 are set such that the one arm portion 88 of the torsion spring 84 and the one end side 74 of the cable 70 in the longitudinal direction form a right angle therebetween in a plan view in the state where the display 12 is opened vertically. Moreover, in this embodiment, the spring constant of the torsion spring 84 is set such that the torsion spring 84 is in a compressed state when the one arm portion 88 of the torsion spring 84 and the one end side 74 of the cable 70 in the longitudinal direction form a right angle therebetween in the plan view.

Note that in FIG. 13, P1 indicates the position of the one arm portion 88 with the display 12 opened to the maximum angle, and P2 indicates the position of the one arm portion 88 with the torsion spring 84 in a free state. As illustrated, in this embodiment, the spring constant of the torsion spring 84 is set such that the torsion spring 84 is in a compressed state even when the display 12 is opened to the maximum angle.

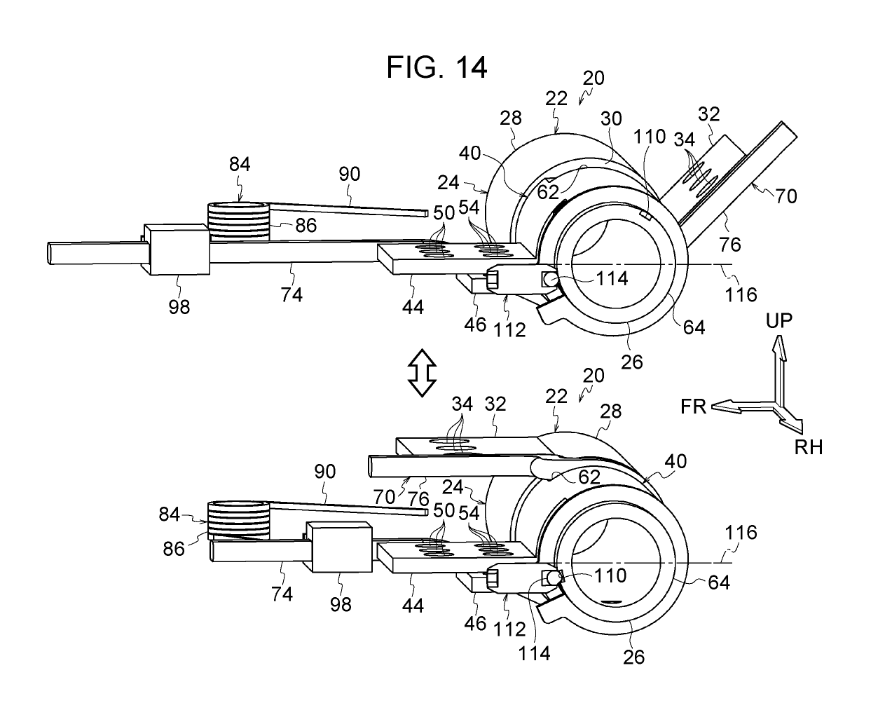

FIG. 14 is a set of views explaining the opening and closing actions of the hinge connector 20. In the top view of FIG. 14, the display 12 is illustrated in the state where it is opened to the maximum angle. In the bottom view of FIG. 14, the display 12 is illustrated in the closed state. In this embodiment, with the spring constant of the torsion spring 84 set as above, the one end side 74 of the cable 70 in the longitudinal direction is kept being biased toward the front side of the control circuitry 14 when the display 12 is opened and closed, as illustrated in FIG. 14. This front side of the control circuitry 14 corresponds to a side away from the hinge 22 along a direction perpendicular to the axial direction of the hinge 22 in a plan view.

Note that the spring constant of the torsion spring 84 is appropriately set such that the torsion spring 84 may be able to pull the cable 70, interposed between the outer periphery of the hinge 22 (the outer periphery of the first shaft portion 26) and the inner periphery of the cover 82.

As illustrated in FIG. 14, the hinge 22 mechanism is provided with a drawing mechanism that draws the display 12 to the side to which the display 12 is closed. Specifically, a recess 110 is formed in the tip portion of the first shaft portion 26, while a ball plunger 112 as an example of a “biasing spring” is provided in the control circuitry 14.

At the tip of the ball plunger 112, a ball 114 is provided which is biased by a spring not illustrated. Each imaginary line 116 illustrated in FIG. 14 is a line extending through the center of the hinge 22 in the horizontal direction of the control circuitry 14. The ball plunger 112 is disposed such that the horizontal direction of the control circuitry 14 is its axial direction and that the center of the ball 114 is located on the lower side of the control circuitry 14 relative to the imaginary line 116.

In this embodiment, the position of the recess 110 is set such that the ball 114 is fitted in the recess 110 in a state where the display 12 is laid on the control circuitry 14. Also, the positions of the recess 110 and the ball plunger 112 are set such that the ball 114 pushes the opening edge of the recess 110 and thereby biases the rotation shaft 24 in the direction in which the display 12 is closed, in the state where the ball 114 is fitted in the recess 110.

Next, the opening and closing actions of the hinge connector 20 in this embodiment will be described.

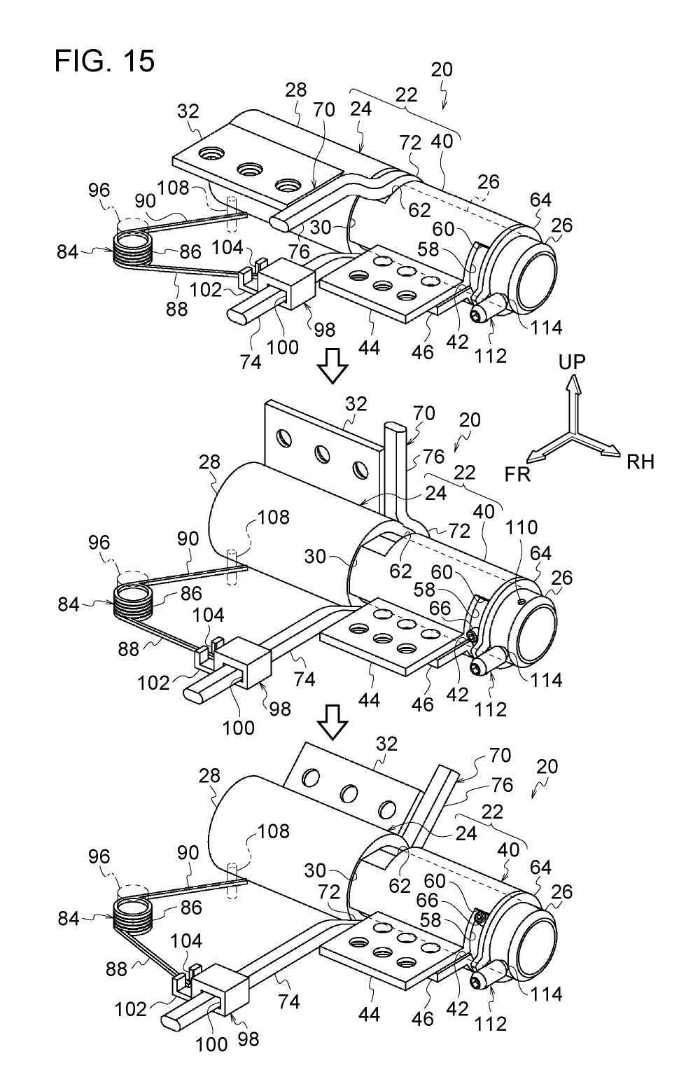

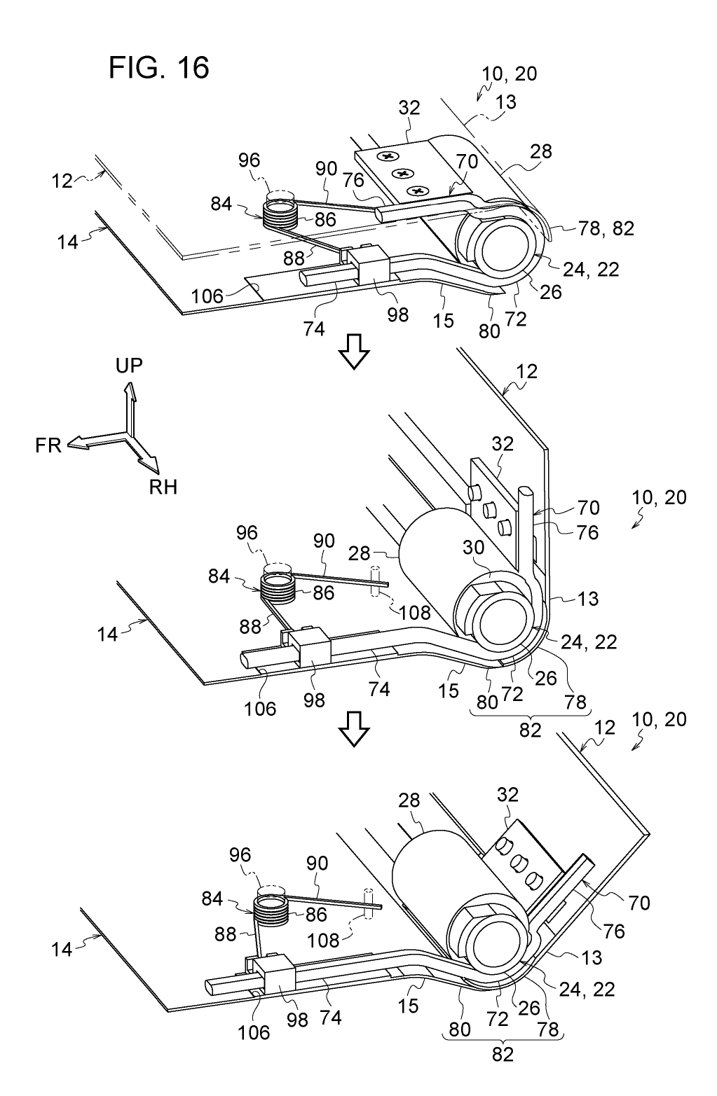

First, the opening action of the hinge connector 20 will be described. FIG. 15 is a set of views explaining the opening action of the hinge connector 20 alone. FIG. 16 is a set of views explaining the opening action of the display 12 and the hinge connector 20. As illustrated in the top views of FIGS. 15 and 16, in the state where the display 12 is closed, the one end 13 (lower end) of the display 12 and the one end 15 (rear end) of the control circuitry 14 are located side by side in the top-bottom direction of the electronic apparatus 10.

In this state, the distance between the one end 13 (lower end) of the display 12 and the one end 15 (rear end) of the control circuitry 14 is long, so that the cable 70 is pulled toward the display 12. Moreover, as the cable 70 is thus pulled toward the display 12, the connection block 98 moves toward the one end 15 (rear end) of the control circuitry 14 such that the torsion spring 84 is fully compressed.

Then, as illustrated in the middle views of the FIGS. 15 and 16, as the display 12 is pivoted in the opening direction, the one end 13 of the display 12 gets closer to the one end 15 of the control circuitry 14 with the opening action of the hinge connector 20. The intermediate portion 72 of the cable 70 in the longitudinal direction possibly slacks as the one end 13 of the display 12 thus gets closer to the one end 15 of the control circuitry 14.

In this embodiment, however, the cable 70 is pulled toward the control circuitry 14 by the torsion spring 84 as much as the slack on the intermediate portion 72 of the cable 70 in the longitudinal direction, thereby suppressing the slacking of the cable 70. This keeps the slack portion of the cable 70 from interfering with the cover 82 or being caught between the hinge 22 and the cover 82, and therefore allows a smooth opening action of the hinge connector 20 and thus smooth opening of the display 12.

Note that the portion of the cable 70 on the front side of the control circuitry 14 relative to the connection block 98 slacks as the cable 70 is pulled toward the control circuitry 14 by the torsion spring 84. The one end of the cable 70 is connected to, for example, the control board inside the control circuitry 14. However, with a curved portion provided between the connection block 98 and the portion connected to the control board, the slack of the cable 70 is absorbed.

In this embodiment, as illustrated in the bottom views of FIGS. 15 and 16, the cable 70 is pulled toward the control circuitry 14 by the torsion spring 84 until the display 12 is opened to the maximum angle. Then, when the display 12 is opened to the maximum angle, the protrusion 66, provided on the first shaft portion 26, comes into contact with the one end 60 of the cutout 58 formed in the support cylinder 40, in width direction of the cutout 58, thereby restricting the pivoting of the display 12 in the opening direction.

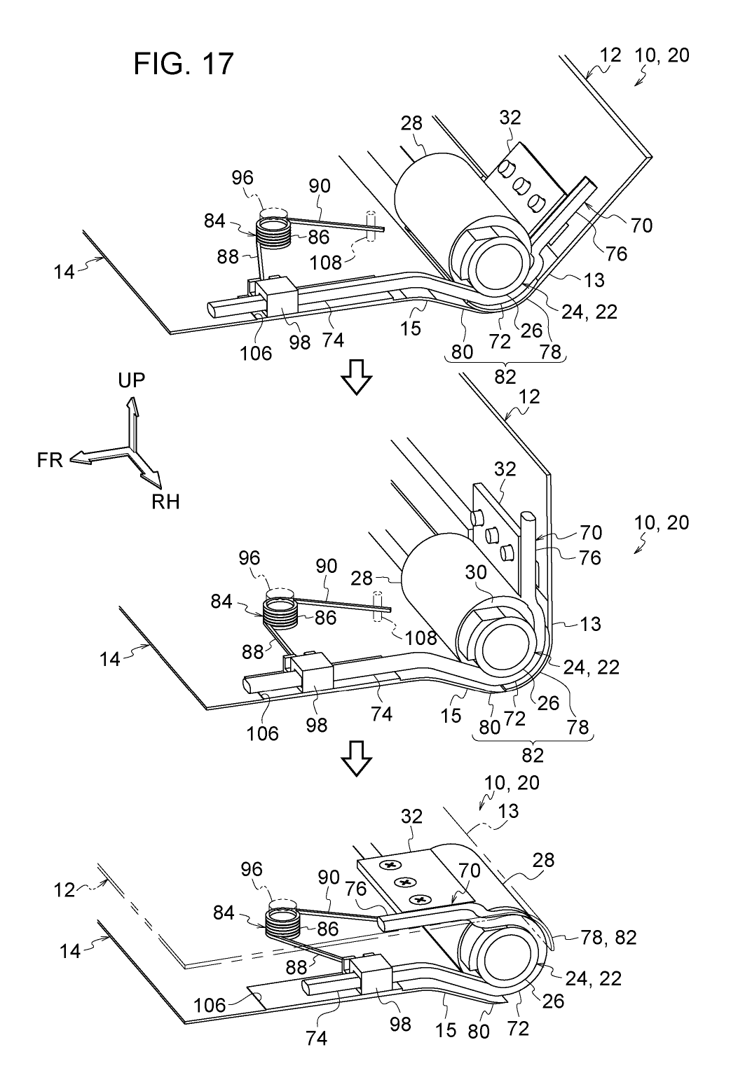

Next, the closing action of the hinge connector 20 will be described. FIG. 17 is a set of views explaining the closing action of the display 12 and the hinge connector 20. As illustrated in the top to middle views of FIG. 17, as the display 12 is pivoted in the closing direction, the one end 13 of the display 12 gets away from the one end 15 of the control circuitry 14 with the closing action of the hinge connector 20. As the one end 13 of the display 12 gets away from the one end 15 of the control circuitry 14, the cable 70 is pulled out by the display 12 from the control circuitry 14 as much as the slack on the cable 70 on the front side of the control circuitry 14 relative to the connection block 98.

Note that when the closing action of the hinge connector 20 is performed, the display 12 pulls the cable 70 and therefore suppresses slacking of the intermediate portion 72 of the cable 70 in the longitudinal direction.

Then, when the display 12 is closed and thereby laid on the control circuitry 14, as illustrated in the bottom view of FIG. 17, the ball 114 of the ball plunger 112 is fitted into the recess 110 in the first shaft portion 26, as illustrated in the bottom view of FIG. 14. Moreover, the ball 114 pushes the opening edge of the recess 110, thereby biasing the rotation shaft 24 in the direction in which the display 12 is closed. Consequently, the display 12 is drawn toward the control circuitry 14 and brought into intimate contact with the control circuitry 14. The opening and closing actions of the hinge connector 20 are performed as described above in this embodiment.

Next, operations and effects of this embodiment will be described.

As described above in detail, according to this embodiment, the control circuitry 14 is provided with the torsion spring 84. The one end portion 92 of this torsion spring 84 is connected to the connection block 98, which is provided to the one end side 74 of the cable 70 in the longitudinal direction, while the opposite end portion 94 of the torsion spring 84 is brought in contact with the protruding portion 108, which is provided to the control circuitry 14. Also, this torsion spring 84 is in a compressed state between the connection block 98 and the protruding portion 108.

Then, as the display 12 is pivoted in the opening direction and thereby allows the opening action of the hinge connector 20, the torsion spring 84 pulls the cable 70 toward the control circuitry 14 and thereby suppresses slacking of the cable 70. This keeps a slack portion of the cable 70 from interfering with the cover 82 or being caught between the hinge 22 and the cover 82, and therefore allows a smooth opening action of the hinge connector 20 and thus smooth opening of the display 12.

In particular, in this embodiment, the cover 82, which is provided to the display 12, is in proximity to the outer periphery of the hinge 22, so that the routing space for the cable 70 around the hinge 22 is narrow. However, by pulling the cable 70 toward the control circuitry 14, the torsion spring 84 suppresses slacking of the cable 70. This may effectively keep the cable 70 from being caught between the hinge 22 and the cover 82.

Also, in this embodiment, the one end side 74 of the cable 70 in the longitudinal direction is routed in the control circuitry 14, and the torsion spring 84 is provided in the control circuitry 14. Here, if, for example, the torsion spring 84 is provided in the display 12, the display area of the display unit 16 may possibly have to be smaller by the space for disposing the torsion spring 84. In this embodiment, however, the torsion spring 84 is provided in the control circuitry 14. The display area of the display unit 16 does therefore not have to be smaller.

Also, according to this embodiment, the rotation shaft 24 is in a hollow cylindrical shape, and the support cylinder 40 is in a surrounding shape surrounding the outer periphery of the rotation shaft 24. In this way, the entire hinge 22, which is formed of the rotation shaft 24 and the support cylinder 40, has a hollow structure. This allows the hinge connector 20 to be lighter and thus the electronic apparatus 10 to be lighter than, for example, those in a case where the hinge 22 has a solid structure.

Next, modifications of this embodiment will be described.

(First Modification)

In the above embodiment, the torsion spring 84 is used as an example of the “spring” that biases the one end side 74 of the cable 70 in the longitudinal direction. However, a member other than the torsion spring 84 may be used as an example of the “spring”.

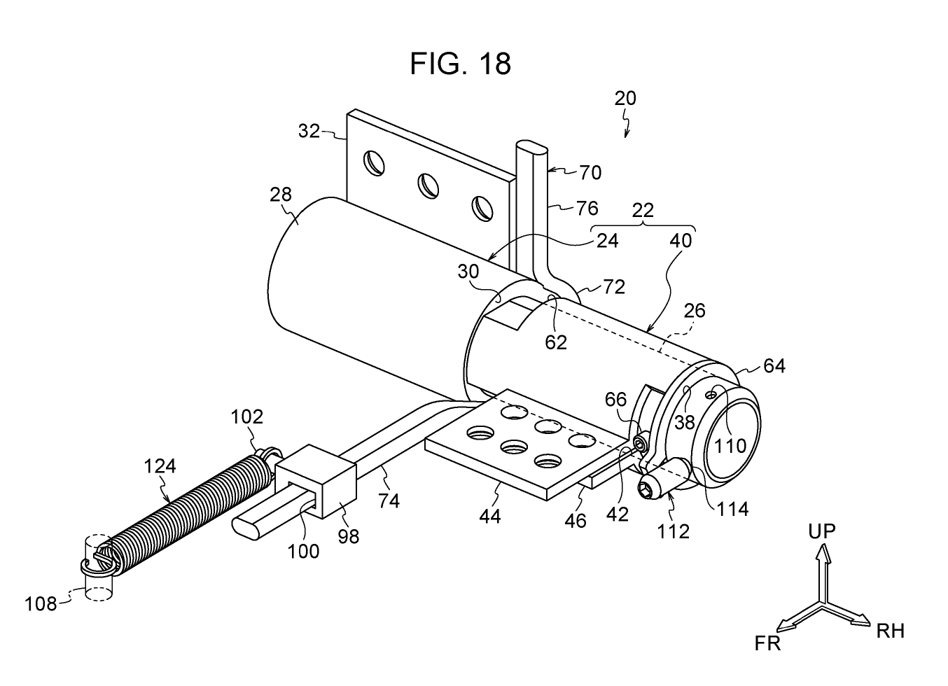

FIG. 18 is a perspective view illustrating a first modification of this embodiment. In this first modification, illustrated in FIG. 18, a coil spring 124 is used as an example of the “spring”. This coil spring 124 is disposed such that the front-rear direction of the control circuitry 14 is its axial direction.

Also, one end portion of the coil spring 124 is connected to the hook 102 of the connection block 98 by being hanged thereon, while the opposite end portion of the coil spring 124 is fixed to the protruding portion 108 provided on the bottom wall of the housing of the control circuitry 14. In this modification, the positions and the like of the connection block 98 and the protruding portion 108 are set such that the coil spring 124 is kept being pulled during the opening and closing actions of the hinge connector 20.

Even with such a configuration, the one end side 74 of the cable 70 in the longitudinal direction is kept being biased toward the front side of the control circuitry 14 when the display 12 is opened and closed, as in the above embodiment. Thus, in the opening action of the hinge connector 20 as a result of pivoting the display 12 in the opening direction, the coil spring 124 pulls the cable 70 toward the control circuitry 14 and thereby suppresses slacking of the cable 70. This keeps a slack portion of the cable 70 from interfering with the cover 82 or being caught between the hinge 22 and the cover 82, and therefore allows a smooth opening action of the hinge connector 20 and thus smooth opening of the display 12.

(Second Modification)

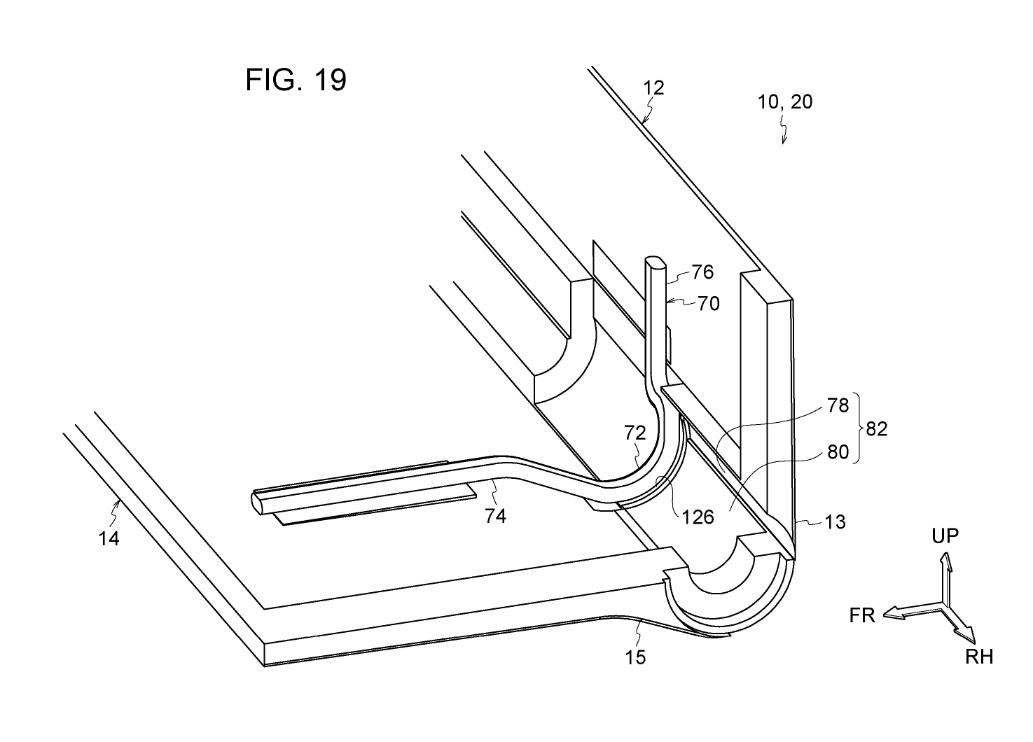

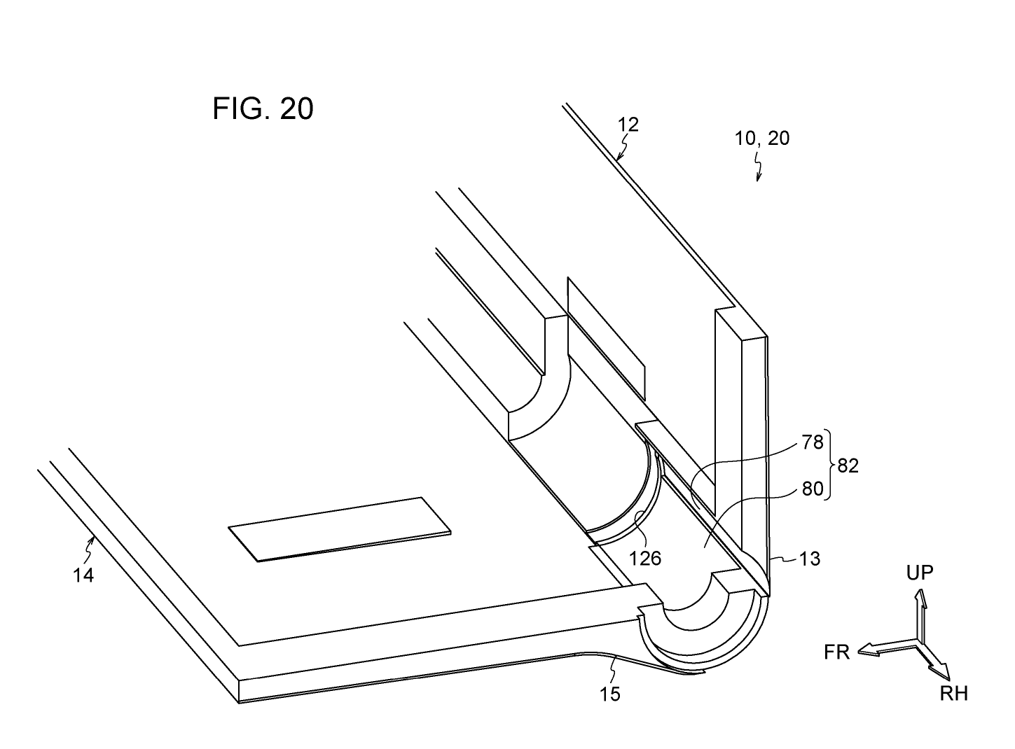

FIG. 19 is a perspective view illustrating a second modification of this embodiment. FIG. 20 is a view illustrating a state without the cable 70 in the second modification illustrated in FIG. 19. In this second modification, illustrated in FIGS. 19 and 20, a guide groove 126 is formed in the inner periphery of the cover 82 (second cover 80). This guide groove 126 extends along the circumferential direction of the cover 82, and the intermediate portion 72 of the cable 70 in the longitudinal direction is inserted in this guide groove 126.

With such a configuration, even when the intermediate portion 72 of the cable 70 in the longitudinal direction moves along the cover 82 with the opening and closing actions of the hinge connector 20, this intermediate portion 72 of the cable 70 in the longitudinal direction may be guided in the circumferential direction of the cover 82 by the guide groove 126. Thus, the intermediate portion 72 of the cable 70 in the longitudinal direction may be kept straight and moved. In this way, it is possible to more effectively suppress slacking of the intermediate portion 72 of the cable 70 in the longitudinal direction.

(Other Modifications)

In the above embodiment, the intermediate portion 72 of the cable 70 in the longitudinal direction is wound on the outer periphery of the first shaft portion 26. However, the intermediate portion 72 of the cable 70 in the longitudinal direction may be wound on the outer periphery of the second shaft portion 28. Alternatively, the intermediate portion 72 of the cable 70 in the longitudinal direction may be wound on the outer periphery of the support cylinder 40.

Also, the torsion spring 84 preferably is provided to the control circuitry 14 and biases the one end side 74 of the cable 70 in the longitudinal direction toward the front side of the control circuitry 14. However, the torsion spring 84 may be provided to the display 12. Further, the torsion spring 84 may bias the opposite end side 76 of the cable 70 in the longitudinal direction toward the upper side of the display 12.

Also, in the above embodiment, the hinge 22 preferably has a hollow structure by forming the rotation shaft 24 in a hollow cylindrical shape and forming the support cylinder 40 in a surrounding shape surrounding the outer periphery of the rotation shaft 24. However, the hinge 22 may have a solid structure.

Also, in the above embodiment, the support cylinder 40 is preferably formed in an open shape including the open portion 42 as one portion in the circumferential direction in order to be able to adjust the friction torque between the support cylinder 40 and the rotation shaft 24. However, the support cylinder 40 may be formed in a hollow cylindrical shape not including the open portion 42.

Also, in the above embodiment, in order to reduce the size of the part around the hinge 22, the cover 82 is provided in proximity to the outer periphery of the hinge 22 to thereby narrow the gap between the inner periphery of the cover 82 and the outer periphery of the hinge 22. In this way, the intermediate portion 72 of the cable 70 in the longitudinal direction is in contact with the outer periphery of the hinge 22 and the inner periphery of the cover 82 during the opening and closing actions of the hinge connector 20. However, the intermediate portion 72 of the cable 70 in the longitudinal direction may be in contact with the outer periphery of the hinge 22 and have a gap between the intermediate portion 72 and the inner periphery of the cover 82 during the opening and closing actions of the hinge connector 20.

Also, in the above embodiment, the protrusion 66, provided on the rotation shaft 24, and the cutout 58, formed in the support cylinder 40, form an angle defining mechanism that defines an opening angle of the display 12. However, this angle defining mechanism may have a different configuration.

Also, in the above embodiment, the recess 110, formed in the rotation shaft 24, and the ball plunger 112, provide in the control circuitry 14, form a drawing mechanism that draws the display 12 to the side to which the display 12 is closed. However, this drawing mechanism may have a different configuration.

Also, in the above embodiment, the hinge connector 20 is used for a laptop personal computer but may be used for electronic apparatuses other than laptop personal computers. Also, the electronic apparatus 10 may be other than a laptop personal computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A hinge connector comprising:
a hinge that includes a rotation shaft and a support cylinder rotatably supporting the rotation shaft;
a cable that is wound on an outer periphery of the hinge; and
a spring that biases one end side of the cable in a longitudinal direction thereof toward a side away from the hinge along a direction perpendicular to an axial direction of the hinge.

2. The hinge connector according to claim 1, wherein the rotation shaft is in a hollow cylindrical shape, and the support cylinder is in a surrounding shape surrounding an outer periphery of the rotation shaft.

3. The hinge connector according to claim 2, wherein the support cylinder is in an open shape including an open portion as one portion thereof in a circumferential direction.

4. The hinge connector according to claim 1, further comprising:
a protrusion that is provided on the rotation shaft and protrudes in a radial direction of the rotation shaft; and
a cutout that is formed in the support cylinder by cutting the support cylinder in an axial direction thereof, the protrusion being inserted in the cutout.

5. The hinge connector according to claim 1, wherein the spring is a torsion spring.

6. The hinge connector according to claim 1, wherein the spring is a coil spring.

7. The hinge connector according to claim 1, further comprising a connection block that is fixed to the one end side of the cable in the longitudinal direction, wherein a hook is formed on the connection block, and one end of the spring is caught on the hook.

8. An electronic apparatus comprising:
a display;
a control circuitry; and
a hinge connector, the hinge connector including a hinge that includes a rotation shaft that is attached to the display, and a support cylinder that is attached to the control circuitry and rotatably supports the rotation shaft;
a cable that is wound on an outer periphery of the hinge and couples the display and the control circuitry to each other; and
a spring that biases one end side of the cable in a longitudinal direction thereof toward a side away from the hinge along a direction perpendicular to an axial direction of the hinge.

9. The electronic apparatus according to claim 8, wherein the display and the control circuitry are provided with a cover formed along the outer periphery of the hinge and covering the outer periphery of the hinge, and the cable is interposed between the outer periphery of the hinge and an inner periphery of the cover.

10. The electronic apparatus according to claim 9, wherein the cable is in contact with the outer periphery of the hinge and the inner periphery of the cover.

11. The electronic apparatus according to claim 9, wherein a guide groove is formed in the inner periphery of the cover, the guide groove extending in a circumferential direction of the cover, and the cable is inserted in the guide groove.

12. The electronic apparatus according to claim 10, wherein a guide groove is formed in the inner periphery of the cover, the guide groove extending in a circumferential direction of the cover, and the cable is inserted in the guide groove.

13. The electronic apparatus according to claim 8, wherein the one end side of the cable in the longitudinal direction is routed in the control circuitry, and the spring is attached to the control circuitry.

14. The electronic apparatus according to claim 8, further comprising a ball plunger that is provided to the control circuitry and biases the rotation shaft in a direction in which the display is closed, in a state where the display is laid on top of the control circuitry.

15. A hinge connector for an electronic device, comprising:
a display;
a control circuitry; and
a hinge connector between and in communication with the display and the control circuitry, the hinge connector includes, a hinge, the hinge including, a rotation shaft attached to the display, and a support cylinder attached to a control board of the control circuitry rotatably supporting the rotation shaft, a cable wound on an outer periphery of the hinge, the cable coupling the display to the control circuitry, a connecting block fixed in a longitudinal direction to an end of the cable, a hook formed, in the longitudinal direction, on the connecting block, and a spring, attached to the control board and in communication with the hook on the connecting block, and that biases the end of the cable in a longitudinal direction perpendicular to an axial direction of the hinge.

16. The hinge connector for the electronic device according to claim 15, wherein when the display is in an open state, the spring pulls the end of the cable via the connecting block a greater distance away from the hinge in a longitudinal direction perpendicular to an axial direction of the hinge than when the display is in a closed state.
